(19) United States
(12) Patent Application Publication
(10) Pub. No.: US 2002/0098753 A1
(43) Pub. Date: Jul. 25, 2002

(54) Low cost fire-block material

(76) Inventors: Donna D. Latham, Radford, VA (US); Christopher G. Corner, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/919,233

(22) Filed: Jul. 31, 2001

Related U.S. Application Data
(60) Provisional application No. 60/221,781, filed on Jul. 31, 2000.

(51) Int. Cl. B32B 5/02; D04H 1/00; B32B 5/12; B32B 27/12; B32B 27/04

(52) U.S. Cl. 442/50; 442/58; 442/136; 442/402

(57) ABSTRACT

A flame-blocking fabric is disclosed that includes a nonwoven scrim and a plurality of flame resistant fibers entangled to and with the nonwoven scrim. The nonwoven scrim may be comprised of fibers that may be chosen from the groups of aramid fibers and melamine fibers. The flame resistant fibers may be chosen from the groups of aramids, polybenzimidazoles and melamine fibers. Also disclosed is an aircraft seat that includes a frame, a foam cushion, a fire-blocking fabric that has a nonwoven scrim and a plurality of flame resistant fibers entangled to and with the nonwoven scrim, and a dress cover. The fire-blocking fabric is thermally resistant enough to meet Federal Aviation Administration seat burn requirements. Also disclosed herein is a method of manufacturing the fire-blocking fabric that includes the steps of laying a web of flame resistant fibers on a nonwoven scrim and entangling the fibers to and with the scrim. The step of entangling the fibers may be accomplished by needle punching, hydroentanglement and/or chemical methods.

### CROSS REFERENCE TO RELATED APPLICATION

This application is related to U.S. provisional patent application entitled “Needle-Punched/Spunlace Combined Nonwoven For Use as Fire-block in Airline Industry,” filed on Jul. 31, 2000, and accorded Ser. No. 60/221,781, which is entirely incorporated herein by reference.

### TECHNICAL FIELD

The present invention is generally related to fabrics and, more particularly, is related to fire-blocking fabrics for use in commercial aircraft.

### BACKGROUND OF THE INVENTION

The Federal Aviation Administration (FAA) has regulations concerning flammability of components within commercial aircraft. For example, 14 C.F.R. 25.853(c) and Appendix F, Part II, specify standards for passenger seats and, more specifically, standards for the flammability requirements of passenger seats.

Generally, aircraft seats include the principal components of a foam core of flotation material, fire-blocking material, and a dress covering. Presently, the FAA requires that aircraft seats must be thermally tested according to various testing criteria. In the testing: (1) at least three sets of seat bottom and seat back cushion specimens must be tested; (2) the fire-blocking material of the seat cushion must completely enclose the cushion foam core material; (3) each specimen tested must be fabricated using both the principal components of the seat cushion and assembly processes intended for use in the actual production of the seat cushions; and (4) for at least two-thirds of the total number of specimens tested, the burn length from the burner must not reach the side of the cushion opposite the burner. In addition, the burn length must not exceed seventeen inches (17″). As defined by 14 C.F.R. Appendix F, Part II, “burn length” is the perpendicular distance from the inside edge of the seat frame (placed closest to the burner) to the farthest point away from the inside edge at which evidence of damage due to flame impingement is present as indicated by partial or complete consumption, charring, or embrittlement. Furthermore, the average percentage weight loss of the seat must not exceed 10%. Additionally, at least two-thirds of the total number of specimens that are tested must not exceed 10% weight loss. See 14 C.F.R., Appendix F to Part 25, which is incorporated herein by reference.

The FAA requires that each set of specimens be tested according to the following procedure: (1) record the weight of each set of seat bottom and seat back cushion specimens to be tested to the nearest 0.02 pound (9 grams); (2) mount the seat bottom and seat back cushion test specimens on the test stand, securing the seat back cushion specimen to the test specimen at top of the seatback cushion; (3) swing the burner into position and ensure that the distance from the exit of the burner cone to the side of the seat bottom cushion specimen is 4±⅛ inches (102±3 mm); (4) swing the burner away from the test position; (5) turn the burner on and allow it to run for 2 minutes to provide adequate warm-up of the burner cone and flame stabilization; (6) begin the test by swinging the burner into the test position and simultaneously start the timing device; (7) expose the seat bottom cushion specimen to the burner flame for two minutes and then turn off the burner; (8) immediately swing the burner away from the test position; (9) terminate test seven minutes after initiating cushion exposure to the flame by use of a gaseous extinguishing agent (i.e., Halon or CO₂); and (10) determine the weight of the specimen remains left on the mounting stand to the nearest 0.02 pound (9 grams), excluding all dropped burnt residue.

In addition to the seat burn test required by the FAA, it is suggested that fire-blocking material also be separately tested via a vertical flame test. This test determines the resistance of the fabric to flame as well as glow propagation and tendency to char. The specimen in this test is a rectangle of fabric measuring three inches (76 mm) by twelve inches (305 mm). Usually, unless otherwise specified in the procurement document, five specimens are tested from each fabric lot. The testing is performed according to the Federal Test Method Standard (FTMS) No. 191A, Method No. 5903.1, which is incorporated herein by reference. In general, this test is performed in the following manner. The specimen is clamped in its holder in such a manner that the entire length of the specimen is exposed. The holder supporting the specimen is inserted into a test cabinet (with the laboratory hood ventilation off) and the burner is positioned so that the middle of the lower edge of the specimen is centered ¾ inch (19 mm) above the burner. A solenoid is opened by starting the timer, thereby exposing the fabric to flame. At the end of the 12-second period, afterflame and afterglow are determined. The specimen is then removed and the laboratory hood fan (if applicable) is turned on until all smoke and fumes are removed.

The afterflame time is the time the specimen continues to flame after the 12 second period (as indicated by the closing of the solenoid). Timing of afterflame is accomplished by means of a timer, stopwatch, or any timing device capable of recording to 0.2 seconds. The afterglow time is the time the specimen continues to glow after the flames have extinguished (as a result of the 12 seconds flame impingement and afterflame). Again, timing of afterglow is accomplished by means of a timer, stopwatch, or any timing device capable of recording to 0.2 seconds. The glow is not be extinguished even when the afterglow time is not being evaluated because of the glow's effect on char length.

After removing the specimen from the cabinet, the specimen is allowed to cool and the char length is measured. The char length is the distance from the end of the specimen that was exposed to the flame to the top of a lengthwise tear made through the center of the charred area. This tear is formed by folding the specimen lengthwise and creasing it by hand along a line through the highest peak of the charred area. A hook is pierced into the specimen from the lower end and inserted into a hole, ¼ inch (6 mm diameter or less) to the side of the charred area. A weight of sufficient size, such that the weight and hook together shall equal the total tearing load, is attached to the hook.

The tearing force is then applied gently to the specimen by grasping the corner of the cloth at the opposite edge of the char and raising the specimen and weight clear of the supporting surface. The specimen is raised in one smooth continuous motion, and should not be jerked or pulled forcefully upward. The end of the tear is marked on the edge of the specimen and the char length measurement made along the undamaged edge.

One exemplary fire-block material that has been manufactured for aircraft seats is a needlepunched blend having a woven aramid scrim. The fiber blend includes Basofil®, which contains melamine fibers manufactured by and commercially available from BASF of Enka, N.C.; polyalkybenzimidazole (PBI), fibers manufactured by and commercially available from Celanese Corporation; and a meta- and para-aramid blend of fibers. The woven scrim is an approximately 2.5 ounces per square yard (osy) blend of meta- and para-aramid fibers, and may be somewhat costly to manufacture. The total weight of the fire-block material is approximately 8.5 osy and has thickness of approximately 0.117 inches. It should be noted that this particular construction is not required for fire-block material of aircraft seats, but it is important to satisfy the seat burn test of the FAA. In view of this, it would be desirable to have an alternative, less expensive fire-block fabric.

### SUMMARY OF THE INVENTION

The present invention provides fire-blocking fabrics that may be used in aircraft seats and methods for producing the fire-blocking fabric.

Briefly described, one embodiment of the fabric, among others, can be designed as follows. The fire-blocking fabric includes a nonwoven scrim and plurality of flame resistant fibers entangled to and with the nonwoven scrim. The nonwoven scrim may comprise aramid fibers. The flame resistant fibers may be chosen from para-aramids, organic fibers and polymers, and melamine fibers. The fire-blocking fabric should be thermally resistant enough to pass the Federal Aviation Administration (FAA) seat burn test. An alternative embodiment of the present invention includes an aircraft seat that includes a frame, a foam cushion, a fire-blocking fabric that comprises a nonwoven scrim and a plurality of flame-resistant fibers entangled to and with the nonwoven scrim, and a dress cover.

The present invention can also be viewed as providing methods for producing a fire-blocking fabric. In this regard, one embodiment of such a method, among others, can be broadly summarized by the following steps of laying a web of flame resistant fibers on a nonwoven scrim and entangling the fibers with the scrim. The flame resistant fibers used in the web may include aramid fibers, polybenzimidazoles, and melamine fibers. The nonwoven scrim may be made of thermally stable fibers, such as aramid fibers, polybenzimidazole fibers, and melamine fibers. The step of entangling the fibers with the scrim may be accomplished by any conventional entanglement method, including but not limited to, for example, needlepunching, hydroentanglement, and chemical methods of entanglement.

Other embodiments, methods, features, and advantages of the present invention will be or become apparent to one with skill in the art upon examination of the following drawings and detailed description. It is intended that all such additional embodiments, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a side view of an aircraft seat, with a cutaway view of a fire-block fabric disposed therein.

FIG. 2 is a side view of the fire-block material exposed in the seat of FIG. 1

FIG. 3 is a side view of a manufacturing process used to construct the fire-block material of the aircraft seat of FIG. 1.

FIG. 4 is a side view of a second embodiment of the fire-block material, taken along the line A-A of FIG. 2.

### DETAILED DESCRIPTION

The invention is generally directed to fabrics comprising a nonwoven scrim that is applied to at least one surface of a nonwoven material. The nonwoven material is entangled with the scrim via any conventional entanglement method, including for example, needlepunching, hydroentanglement, and chemical methods of entanglement. It has been determined that acceptable FAA seat burn test results can be obtained with this fabric, with lower manufacturing costs.

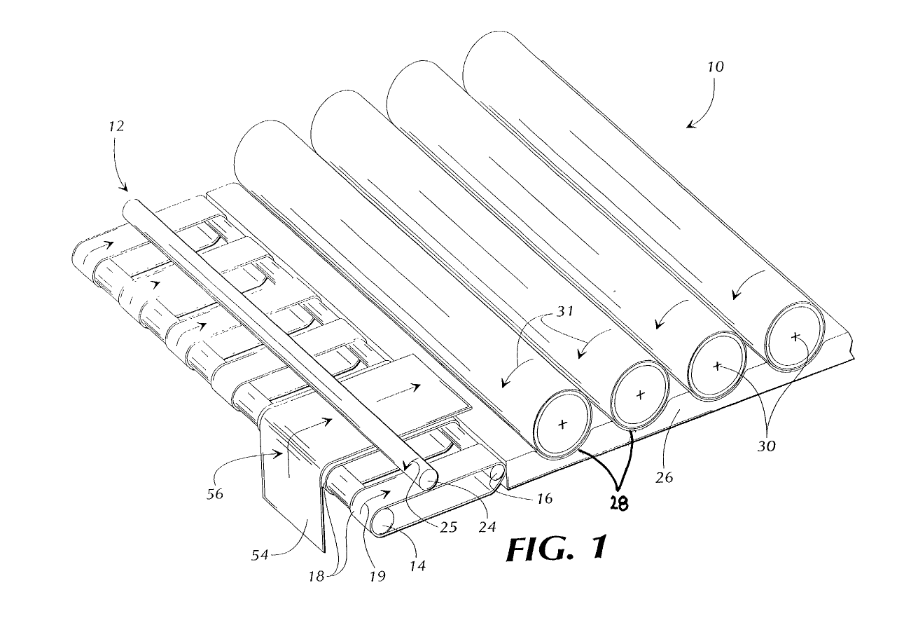

Referring now to FIG. 1, depicted is a side view of an aircraft seat 50 with a fire-block fabric 100 shown in cutaway. Generally speaking, the aircraft seat 50 includes a rigid frame 55 that may be metal, an interior foam cushion (not identified), a fire-blocking fabric 100, and a dress cover 60 that covers the fire-block material.

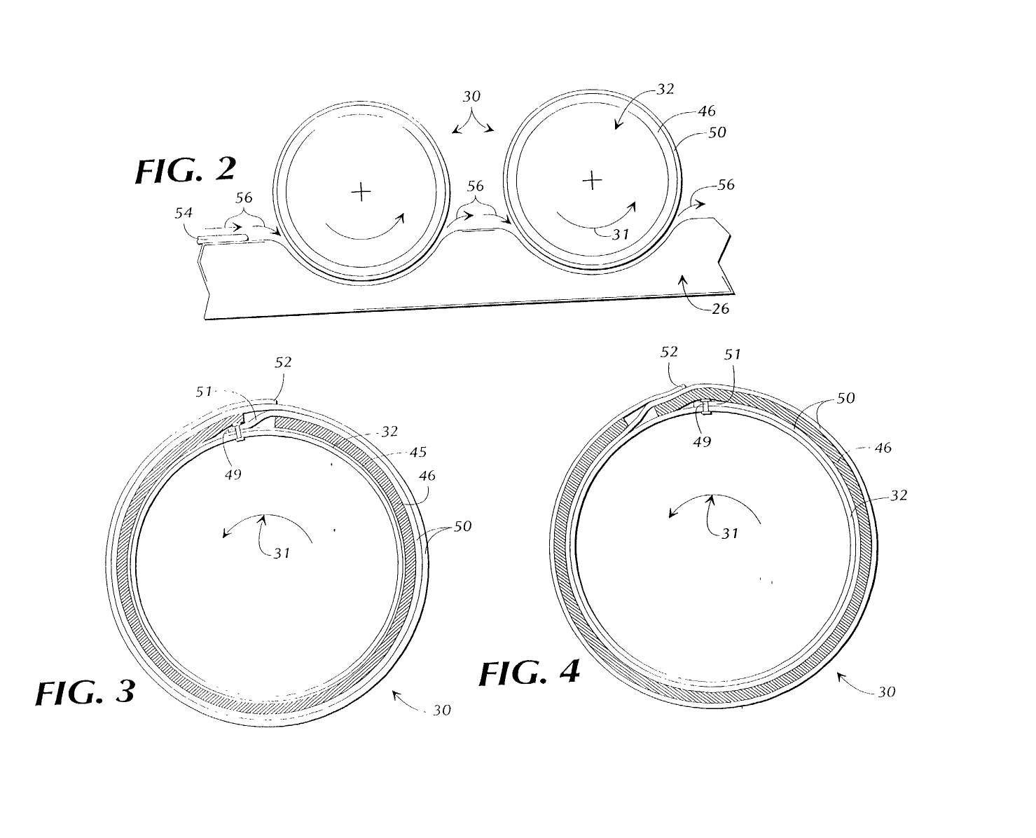

As described previously and shown in FIG. 2, the fire-block fabric 100 includes a nonwoven scrim 120 and a plurality of fire resistant fibers 110 that are entangled to and with the nonwoven scrim 120. The nonwoven scrim 120 is usually made of, for example, aramid fibers, polybenzimidazole fibers, and/or melamine fibers, or any combination thereof. In a preferred embodiment, the nonwoven scrim 120 is made of aramid fibers in a ratio of approximately 0 to 100% para-aramid fibers and 0 to 100% meta-aramid fibers. Preferably, the nonwoven scrim 120 is made of para- and meta-aramid fibers in a ratio of approximately 65% para-aramid fibers to 35% meta-aramid fibers. Further, the scrim 120 may be made of a combination of para-aramid fibers, meta-aramid fibers, polybenzimidazole fibers and/or melamine fibers. The ranges of each fiber component may range from approximately 0-95%. The scrim 120 may, for example, have a weight of approximately one-half to four ounces per square yard (osy). In one embodiment, the scrim 120 weighs approximately 2.5 osy. The scrim 120 usually comprises, for example, of approximately 10% to approximately 60% of the fire-block fabric 100. Further, the scrim typically has an approximate thickness of 0.001 to 0.07 inches. One skilled in the art would understand that the scrim 120 could be more or less thick, depending upon the desired application. Although FIG. 2 shows a distinct line separating the scrim 120 from the layers of flame resistant fibers 110, distinct transition lines may not exist between the layers, but rather the scrim portion 120 of the fire-block material 110 may be more dense than the rest of the fire-block material 110, thus imparting greater strength and durability to the fire-block material 200.

The flame resistant fibers of the nonwoven material 110 that are entangled with the nonwoven scrim 120 may be, for example, any one, all, or any combination of aramid, polybenzimidazole (PBI), and melamine fibers. Preferably, the flame resistant fibers comprise aramid fibers. The term “aramid” is used to designate aromatic polyamides that are formed by reactions of aromatic diacid chlorides with aromatic diamines to produce amide linkages in an amide solvent. As known in the art, aramid fibers are typically available in two distinct compositions, namely meta-type fibers composed of poly(m-phenylene isophthalamide), commonly referred to as meta-aramid fibers, and para-type fibers composed of poly(p-phenylene-terephthalamide), which are commonly referred to as para-aramid fibers. Meta-aramid fibers are currently available from DuPont of Wilmington, Del., in several forms under the trademark NOMEX®. For example, NOMEX T-450® is 100% meta-aramid; NOMEX T-455® is a blend of 95% NOMEX® and 5% KEVLAR® (para-aramid); and NOMEX IIIA® (also known as NOMEX T-462®) is 93% NOMEX®, 5% KEVLAR®, and 2% carbon core nylon. In addition, meta-aramid fibers are available under the trademarks CONEX® and APYEIL® that are produced by Teijin Limited of Japan and Unitika Limited of Japan, respectively. Para-aramid fibers are currently available under the trademarks KEVLAR®, TECHNORA®, and TWARON®, from DuPont and Teijin, respectively.

PBI, or polybenzimidazole, is prepared from tetra-aminobiphenyl and diphenyl isophthalate spun via a dry spinning process using dimethyl acetamide as the solvent. PBI fiber characteristics include no melting point, lack of ability to ignite, retention of fiber integrity and suppleness upon flame exposure, high char yield, ability to be dyed dark shades with basic dyes following caustic pretreatment, mildew and age resistance, and abrasion resistance.

Melamine is a manufactured fiber in which the fiber-forming substance is a synthetic polymer composed of at least 50% by weight of a cross-linked melamine polymer. Although the production process is proprietary, it is based on a unique melamine chemistry that results in a cross-linked, non-thermoplastic polymer of melamine units joined by methylene and dimethylene ether linkages. In the polymerization reaction, methylol derivatives of melamine react with each other to form a three-dimensional structure. This structure is the basis for the fiber heat stability, solvent resistance, and flame resistance. In accordance with the above descriptions, it is to be noted that, in the present disclosure, when a material name is followed by the term “fiber,” the fiber described is not limited to fibers composed exclusively of the named material.

The fire-block fabric 100 may have an approximate weight, for example, of approximately 6.8 to 9.0 osy. The thickness of the fabric may vary, depending on desired application for the fabric. By way of example, the thickness can range from approximately 0.100 to 0.129 inches. Further, the fabric may have a tensile strength, for example but not limited to, from greater than approximately 25 pounds in the machine direction to greater than approximately 60 pounds in the cross-machine direction. Preferably, the tensile strength of the fabric of the roll cover 50 may be approximately 60 pounds in the machine direction and approximately 95 pounds in the cross-machine direction. Thus, the fabric is strong and therefore well-suited for use in aircraft seat construction. Moreover, the fabric 100 is fire resistant enough to satisfy FAA seat burn requirements. Table 1 below charts a comparison of a conventional fire-block fabric, a scrim-less fabric, and the fire-block fabric of the present invention with a nonwoven scrim 120. It should be noted that the values listed below are only approximate, and will vary depending on the composition of fibers used for the flame resistant fibers 110 and nonwoven scrim 120.

TABLE 1
Tensile Strength Comparison

| Tensile | | | |
|---|---|---|---|
| Strength | 7.0 osy traditional | 7.0 osy invention | 7.0 osy scrim-less |
| (lb.) | fire-block fabric | fire-block fabric | fabric |
| Machine | 80 | 60 | 25 |
| direction | | | |
| Cross- | 95 | 95 | 30 |
| Machine | | | |
| Direction | | | |

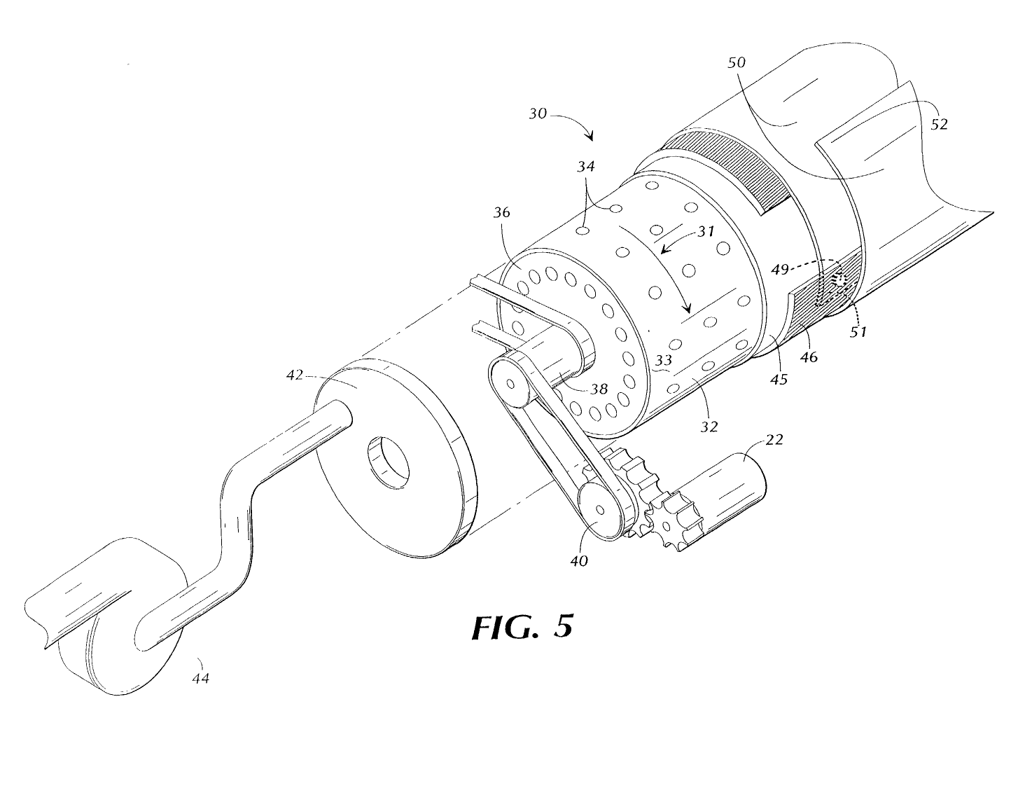

As identified above, the inventive fabric 100 can be constructed using various different entanglement methods. For example, the fabric can be made through a needlepunching process. Referring to FIG. 3, illustrated is an example manufacturing process. This process comprises the steps of laying a web of flame resistant fibers 110 on a nonwoven scrim 120 and entangling the fibers 110 with the scrim 120. As indicated in FIG. 3, the fibers 110 can be entangled with the scrim 120 by needlepunching. In particular, barbed needles 135 of the needlepunch mechanism 130 are pushed through the fibers 110. The barbed needles 135 catch the fibers 110 on the surface and push them into the scrim 120, densifying the structure and producing strength through entanglement. Needling can be done from both sides of the scrim 120, and penetration of the needles does not have to be perpendicular to the fibers 110 and scrim 120 as shown in FIG. 3.

In addition to needlepunching, various other techniques can be used to entangle the fibers 110 with the scrim 120. For example, hydroentanglement or chemical adhesion can be used to combine the fibers 110 and the scrim 120. Hydroentanglement involves the use of fine jets of water to push the fibers 110 through the scrim 120. In general, these jets of water do not exert as great a force on fibers as that produced during needlepunching. Therefore, hydroentangled structures are usually less dense and more flexible that those produced by needlepunching. Hydroentanglement does have an advantage, however, over needlepunching in that it can be used to bond relatively thin fabric.

As for entangling the fibers 110 via chemical adhesion or bonding, adhesive can be used to bind the fibers 110 to the scrim 120. The adhesive may be included as either a secondary treatment, or in the form of adhesive-containing fibers that may be manufactured into the fire-block material 100.

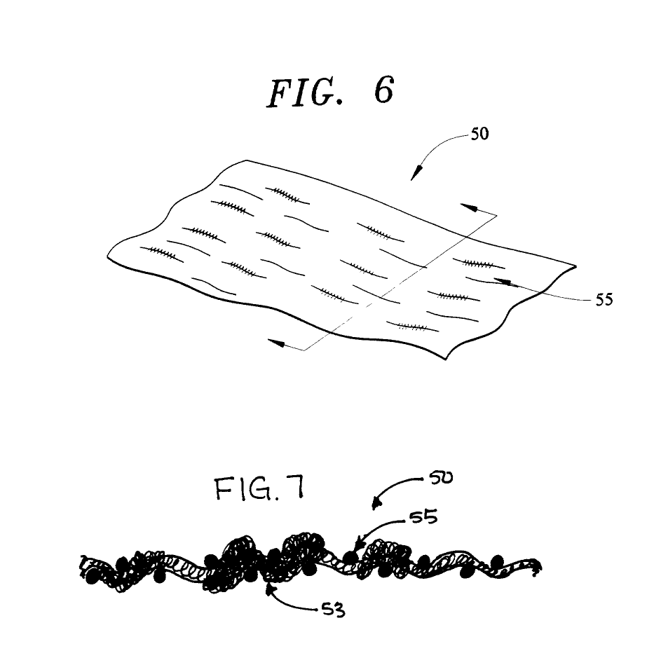

FIG. 4 depicts an alternative fire-block material 200 that may be formed from the disclosed methods. In particular, FIG. 4 shows a cross-section of the fabric 200 taken along the line A-A of FIG. 3. As indicated in FIG. 4, the fire-block material 200 includes a layer of flame resistant fibers 110 that is entangled with the scrim 120. The material 200 includes an additional layer of flame resistant fibers 110 on the opposite side of the scrim 120 from the first layer of fibers 110. Although FIG. 4 shows a distinct line separating the scrim 120 from the layers of flame resistant fibers 110, distinct transition lines may not exist between the layers, but rather the scrim portion 120 of the fire-block material 110 may be more dense than the rest of the fire-block material 110, thus 30 imparting greater strength and durability to the fire-block material 200.

It should be emphasized that the above-described embodiments of the present invention are merely possible examples of implementations, and are merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Having thus described the invention, at least the following is claimed:

1. A fire-blocking fabric comprising:
a nonwoven scrim; and
a plurality of flame resistant fibers entangled to and with the nonwoven scrim.

2. The fabric of claim 1, wherein the nonwoven scrim comprises at least one of aramid fibers, polybenzimidazole fibers, and melamine fibers.

3. The fabric of claim 1, wherein the nonwoven scrim comprises para-aramid and meta-aramid fibers in a ratio of approximately 65 para-aramid fiber to 35 meta-aramid fiber.

4. The fabric of claim 1, wherein the flame resistant fibers comprise at least one of aramid fibers, polybenzimidazole fibers, and melamine fibers.

5. The fabric of claim 1, wherein the scrim has a weight of approximately one-half to approximately four ounces per square yard.

6. The fabric of claim 1, wherein the fabric has a weight of approximately 4 to approximately 9 ounces per square yard.

7. The fabric of claim 1, whereby the flame resistant fibers are entangled to and with the nonwoven scrim by needlepunching.

8. The fabric of claim 1, whereby the flame resistant fibers are hydroentangled to and with the nonwoven scrim.

9. The fabric of claim 1, whereby the flame resistant fibers are chemically bonded to and with the nonwoven scrim.

10. The fabric of claim 1, wherein the scrim comprises approximately 11 percent to approximately 60 percent of the fabric by weight.

11. The fabric of claim 1, wherein the scrim has a thickness of approximately 0.001 to approximately 0.07 inches.

12. The fabric of claim 1, wherein the flame resistant fibers have a thickness of approximately 0.031 to approximately 0.128 inches.

13. The fabric of claim 1, wherein the fabric satisfies FAA seat burn requirements.

14. The fabric of claim 1, wherein the fabric has a tensile strength of greater than approximately 25 pounds in the machine direction and greater than approximately 30 pounds in the cross-machine direction.

15. A fire-blocking fabric comprising:
a nonwoven scrim comprising approximately 50% melamine fibers, approximately 25% para-aramid fibers, and approximately 25% meta-aramid fibers; and
a plurality of flame resistant fibers that are entangled to and with the nonwoven scrim, the fibers including at least one of aramid fibers, polybenzimidazole fibers, and melamine fibers.

16. The fabric of claim 15, wherein the fabric satisfies FAA seat burn requirements.

17. The fabric of claim 15, wherein the fabric has a tensile strength of greater than approximately 25 pounds in the machine direction and greater than approximately 30 pounds in the cross-machine direction.

18. The fabric of claim 15, wherein the scrim has a weight of approximately one-half to approximately four ounces per square yard.

19. The fabric of claim 15, wherein the fabric has a weight of approximately 4 to approximately 9 ounces per square yard.

20. The fabric of claim 15, whereby the flame resistant fibers are entangled to and with the nonwoven scrim by needlepunching.

21. The fabric of claim 15, whereby the flame resistant fibers are chemically bonded to the nonwoven scrim.

22. The fabric of claim 15, whereby the flame resistant fibers are hydroentangled with the nonwoven scrim.

23. The fabric of claim 15, wherein the scrim comprises approximately 11 percent to approximately 60 percent of the fabric by weight.

24. The fabric of claim 15, wherein the scrim has a thickness of approximately 0.001 to approximately 0.07 inches.

25. The fabric of claim 15, wherein the flame resistant fibers have a thickness of approximately 0.031 to approximately 0.128 inches.

26. A fire-blocking fabric comprising:
a nonwoven scrim comprising approximately 0-95% by weight melamine fibers, approximately 0-95% by weight para-aramid fibers, approximately 0-95% by weight meta-aramid fibers, and approximately 0-95% by weight polybenzimidazole fibers; and
a plurality of flame resistant fibers that are entangled to and with the nonwoven scrim, the fibers including at least one of aramid fibers, polybenzimidazole fibers, and melamine fibers.

27. An aircraft seat, comprising:
a frame;
a cushion;
a fire-blocking fabric comprising
a nonwoven scrim, and
a plurality of flame resistant fibers entangled to and with the nonwoven scrim; and
a dress cover.

28. The seat of claim 27, wherein the nonwoven scrim comprises aramid fibers, polybenzimidazole fibers, and melamine fibers.

29. The seat of claim 27, wherein the nonwoven scrim comprises para-aramid and meta-aramid fibers in a ratio of approximately 65 para-aramid fibers to approximately 35 meta-aramid fiber.

30. The seat of claim 27, wherein the flame resistant fibers comprise at least one of aramid fibers, polybenzimidazole fibers, and melamine fibers.

31. The seat of claim 27, where the scrim has a weight of approximately one-half to approximately four ounces per square yard.

32. The seat of claim 27, wherein the fire-blocking fabric has a weight of approximately 4 to approximately 9 ounces per square yard.

33. The seat of claim 27, whereby the flame resistant fibers are entangled to and with the nonwoven scrim by needlepunching.

34. The seat of claim 27, whereby the flame resistant fibers are hydroentangled to and with the nonwoven scrim.

35. The seat of claim 27, whereby the flame resistant fibers are chemically bonded to and with the nonwoven scrim.

36. The seat of claim 27, wherein the scrim comprises approximately 11 percent to approximately 60 percent by weight of the fire-blocking fabric.

37. The seat of claim 27, wherein the scrim has a thickness of approximately 0.001 to approximately 0.07 inches.

38. The seat of claim 27, wherein the fibers have a thickness of approximately 0.031 to approximately 0.128 inches.

39. The seat of claim 27, wherein the fire-blocking fabric satisfies FAA seat bum requirements.

40. The seat of claim 27, wherein the fabric has a tensile strength of greater than approximately 25 pounds in the machine direction and greater than approximately 30 pounds in the cross-machine direction.

41. A method for constructing a fire-blocking fabric for use in an aircraft seat comprising the steps of:
laying a web of flame resistant fibers on a nonwoven scrim; and
entangling the fibers to and with the nonwoven scrim.

42. The method of claim 41, wherein the scrim comprises at least one of aramid fibers, polybenzimidazole fibers, and melamine fibers.

43. The method of claim 41, wherein the flame resistant fibers comprise at least one of aramid fibers, polybenzimidazole fibers, and melamine fibers.

44. The method of claim 41, wherein the step of entangling the fibers to and with the nonwoven scrim comprises needlepunching the fibers and nonwoven scrim.

45. The method of claim 41, wherein the step of entangling the fibers to and with the nonwoven scrim comprises hydroentangling the fibers and nonwoven scrim.

46. The method of claim 41, wherein the step of entangling the fibers to and with the nonwoven scrim comprises chemically bonding the flame resistant fibers to the nonwoven scrim

47. The method of claim 41, wherein the step of entangling the fibers to and with the nonwoven scrim comprises chemically entangling the fibers and nonwoven scrim.

48. The method of claim 41, wherein a fire-blocking fabric satisfies FAA seat bum requirements.
